(19) United States
(12) Patent Application Publication
(10) Pub. No.: US 2023/0199567 A1
(43) Pub. Date: Jun. 22, 2023

(54) METHOD AND APPARATUS FOR DETERMINING CONFIGURATION OF CONTROL RESOURCE SET, AND COMPUTER READABLE STORAGE MEDIUM

(71) Applicant: SPREADTRUM COMMUNICATIONS (SHANGHAI) CO., LTD., Shanghai (CN)

(72) Inventors: Huayu ZHOU, Pudong New Area, Shanghai (CN); Sicong ZHAO, Pudong New Area, Shanghai (CN); Zhengang PAN, Pudong New Area, Shanghai (CN)

(21) Appl. No.: 17/926,243

(22) PCT Filed: May 12, 2021
(86) PCT No.: PCT/CN2021/093256

§ 371 Date: Nov. 18, 2022

(30) Foreign Application Priority Data
May 18, 2020 (CN) 202010420321.2

(51) Int. Cl. H04W 28/24; H04L 5/00; H04W 28/02

(52) U.S. Cl. CPC H04W 28/24; H04L 5/0053; H04W 28/0268

(57) ABSTRACT

A method and apparatus for determining configuration of a control resource set, and a computer readable storage medium are provided. The method includes receiving signaling; and determining the configuration of the control resource set based on the signaling.

### CROSS-REFERENCE TO RELATED APPLICATIONS

This is the U.S. national stage of application No. PCT/CN2021/093256, filed on May 12, 2021. Priority under 35 U.S.C. §119(a) and 35 U.S.C. §365(b) is claimed from Chinese Application No. 202010420321.2 filed May 18, 2020, the disclosure of which is also incorporated herein by reference.

### TECHNICAL FIELD

The present disclosure generally relates to radio communication technology field, and more particularly, to a method and apparatus for determining configuration of a control resource set, and a computer readable storage medium.

### BACKGROUND

With the development of communication technology, New Radio (NR) in future can support low-complexity user equipment (UE). Low-complexity UEs are low in cost and applicable for Machine Type Communication (MTC) or Internet of Things (IoT).

Compared with conventional UEs, low-complexity UEs have smaller bandwidth, fewer antennas, lower capacity, and relaxed UE processing time. Specifically, a bandwidth is reduced from 100 MHz to 50 MHz, 20 MHz, 10 MHz or 5 MHz, and a number of receiving antennas is reduced from 4 to 2 or 1. A decrease in the bandwidth and the number of antennas causes a decrease in coverage or effective cell radius. This is because that the decrease in the bandwidth leads to a decrease in a maximum Aggregation Level (AL) of a Physical Downlink Control Channel (PDCCH), resulting in a decrease in a coding gain, and the decrease in the number of receiving antennas leads to a decrease in a receiving diversity gain.

Therefore, some mechanisms for PDCCH coverage recovery are introduced, including prolonging a duration of a Control Resource Set (CORESET), thereby increasing the maximum aggregation level, and PDCCH repeated transmission, in which a UE can merge multiple PDCCHs to indirectly increase PDCCH time domain resources.

During an initial access procedure, the UE monitors a common PDCCH configured by a Master Information Block (MIB), where a CORESET corresponding to the common PDCCH configured by the MIB is generally called CORESET 0 (as it has an identity of 0). As low-complexity UEs require coverage recovery, CORESET 0 for low-complexity UEs needs to correspond to different coverage recovery configurations. For example, when a coverage loss is 3 dB, a configuration corresponding to coverage recovery of 3 dB is required, and when the coverage loss is 6 dB, a configuration corresponding to coverage recovery of 6 dB is required.

### SUMMARY

Embodiments of the present disclosure may enable low-complexity UEs to adaptively determine configuration of a control resource set based on a coverage recovery requirement.

In an embodiment of the present disclosure, a method for determining configuration of a control resource set is provided, including receiving signaling; and determining the configuration of the control resource set based on the signaling.

In an embodiment of the present disclosure, a computer-readable storage medium having computer instructions stored therein is provided, wherein when the computer instructions are executed, any one of the above methods is performed.

In an embodiment of the present disclosure, an apparatus for determining configuration of a control resource set is provided and includes a memory and a processor, wherein the memory has computer instructions stored therein, and when the processor executes the computer instructions, any one of the above methods is performed.

### BRIEF DESCRIPTION OF THE DRAWINGS

FIG. 1 is a flow chart of a method for determining configuration of a control resource set according to an embodiment; and

FIG. 2 is a structural diagram of an apparatus for determining configuration of a control resource set according to an embodiment.

### DETAILED DESCRIPTION

As described in the background, it becomes an urgent problem how the low-complexity UEs can adaptively determine configuration of the control resource set based on a coverage recovery requirement.

In the embodiments of the present disclosure, by receiving signaling from a network side, and determining configuration of a control resource set based on the signaling, a low-complexity UE may be able to adaptively determine configuration of the control resource set.

In order to clarify the objects, characteristics and advantages of the disclosure, embodiments of present disclosure will be described in detail in conjunction with accompanying drawings.

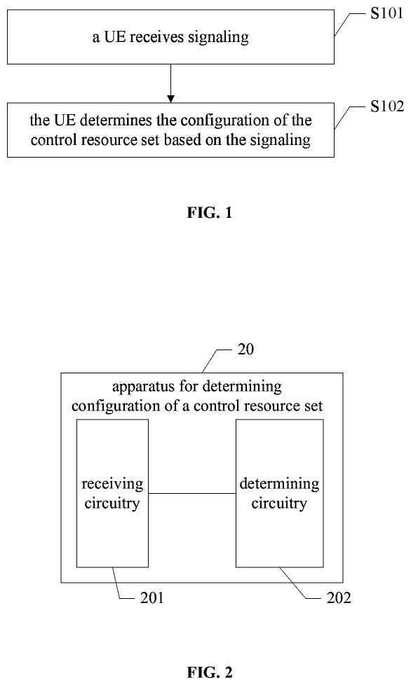

In an embodiment, a method for determining configuration of a control resource set is provided. Referring to FIG. 1, details of the method are provided via specific steps below.

In some embodiments, the method including S101 and S102 may be performed by a chip (such as a baseband chip) with a data processing function in a UE, or by a chip module containing a chip with a data processing function in the UE.

In S101, a UE receives signaling.

In some embodiments, the UE may receive the signaling from a network side. The signaling received from the network side may be a MIB signaling.

In some embodiments, the UE may be a low-complexity UE. In practice, a low-complexity UE has smaller bandwidth, fewer antennas, lower capacity, and relaxed UE processing time. Specifically, a bandwidth is reduced from 100 MHz to 50 MHz, 20 MHz, 10 MHz or 5 MHz, and a number of receiving antennas is reduced from 4 to 2 or 1.

In S102, the UE determines the configuration of the control resource set based on the signaling.

In some embodiments, after receiving the signaling, the UE may determine the configuration of the control urce set based on the signaling. The configuration of the control resource set determined based on the signaling may be a duration of the control resource set.

In some embodiments, a network side may carry configuration of several control resource sets in MIB signaling. After receiving the MIB signaling, the UE may determine the configuration of the control resource set, such as selecting configuration of the control resource set, based on a parameter, for example, its own parameter (bandwidth and/or a number of receiving antennas, etc.). The parameter may be a coverage recovery value (such as a desired coverage recovery value or coverage recovery level), or a type of the UE, or at least one of bandwidth of the UE and a number of receiving antennas of the UE. The UE may determine the coverage recovery value based on its own parameter (the bandwidth and/or the number of the receiving antennas). The UE may determine the type of the UE based on its own parameter (the bandwidth and/or the number of the receiving antennas). The bandwidth of the UE may include bandwidth supported by the UE, maximum bandwidth supported by UE, channel bandwidth of the UE, channel bandwidth supported by the UE, or maximum channel bandwidth supported by the UE.

In some embodiments, the control resource set determined by the UE may be a control resource set with an identity of 0 which is also called CORESET 0. Generally, the control resource set with the identity of 0 is a control resource set configured by MIB, or by PDCCH-ConfigSIB1, or by ControlResourceSetZero. Accordingly, the UE may determine a duration of the control resource set with the identity of 0 based on the above parameter.

Correspondence between the parameter and the duration of the control resource set is described below.

In some embodiments, said determining the duration of the control resource set based on a coverage recovery value includes at least one of the following: determining that the duration of the control resource set is 4 symbol length based on the coverage recovery value being 3 dB; determining that the duration of the control resource set is 8 symbol length based on the coverage recovery value being 6 dB; or determining that the duration of the control resource set is 8 symbol length based on the coverage recovery value being 9 dB.

Accordingly, said determining the duration of CORESET 0 based on a coverage recovery value includes at least one of the following: determining that the duration of CORESET 0 is 4 symbol length based on the coverage recovery value being 3 dB; determining that the duration of CORESET 0 is 8 symbol length based on the coverage recovery value being 6 dB; or determining that the duration of CORESET 0 is 8 symbol length based on the coverage recovery value being 9 dB.

In some embodiments, the UE may determine the duration of the control resource set merely based on the bandwidth of the UE. The UE may determine the duration of the control resource set merely based on the number of the receiving antennas of the UE. The UE may determine the duration of the control resource set based on both the bandwidth of the UE and the number of the receiving antennas of the UE.

In some embodiments, the UE may determine that the duration of the control resource set is M symbol length based on the bandwidth of the UE being less than X physical resource blocks and the number of the receiving antennas of the UE being Z.

In some embodiments, X is 48, and Z is 2. In this case, if the UE determines the duration of the control resource set based on both the bandwidth of the UE and the number of the receiving antennas of the UE, the UE determines that the duration of the control resource set is 4 symbol length based on the bandwidth of the UE being less than 48 Physical Resource Blocks (PRBs) and the number of the receiving antennas of the UE being 2.

X is set to be 48, and Z is set to be 2, so that the number of PRBs of the control resource set may be 24. A maximum aggregation level is 4 when the duration of the control resource set is 1 symbol length, and the maximum aggregation level is 8 when the duration of the control resource set is 2 symbol length. If the duration of the control resource set increases to 4 symbol length, the maximum aggregation level may be 16.

In some embodiments, X is 48, and Z is 1. In this case, if the UE determines the duration of the control resource set based on both the bandwidth of the UE and the number of the receiving antennas of the UE, the UE determines that the duration of the control resource set is 8 symbol length based on the bandwidth of the UE being less than 48 PRBs and the number of the receiving antennas of the UE being 1.

X is set to be 48, and Z is set to be 1, so that the number of PRBs of the control resource set may be 24. A maximum aggregation level is 4 when the duration of the control resource set is 1 symbol length, and the maximum aggregation level is 8 when the duration of the control resource set is 2 symbol length. If the duration of the control resource set increases to 8 symbol length, the maximum aggregation level may be 32.

In some embodiments, the UE may determine the duration of the control resource set based on the number of the receiving antennas of the UE. In some embodiments, the UE may determine that the duration of the control resource set is M symbol length based on the number of the receiving antennas of the UE being Z.

In some embodiments, Z is 2. In this case, the UE determines that the duration of the control resource set is 4 symbol length based on the number of the receiving antennas of the UE being 2.

Z is set to be 2, so that the number of PRBs of the control resource set may be 24. A maximum aggregation level is 4 when the duration of the control resource set is 1 symbol length, and the maximum aggregation level is 8 when the duration of the control resource set is 2 symbol length. If the duration of the control resource set increases to 4 symbol length, the maximum aggregation level may be 16.

In some embodiments, Z is 1. In this case, the UE determines that the duration of the control resource set is 8 symbol length based on the number of the receiving antennas of the UE being 1.

Z is set to be 1, so that the number of PRBs of the control resource set may be 24. A maximum aggregation level is 4 when the duration of the control resource set is 1 symbol length, and the maximum aggregation level is 8 when the duration of the control resource set is 2 symbol length. If the duration of the control resource set increases to 8 symbol length, the maximum aggregation level may be 32.

Accordingly, in some embodiments, the UE may determine the duration of CORESET 0 merely based on the bandwidth of the UE, or merely based on the number of the receiving antennas of the UE or based on both the bandwidth of the UE and the number of the receiving antennas of the UE.

The UE determines that the duration of CORESET 0 is 4 symbol length based on the bandwidth of the UE being less than 48 PRBs and the number of the receiving antennas of the UE being 2.

In some embodiments, X is set to be 48, and Z is set to be 2, so that the number of PRBs of CORESET 0 may be 24. A maximum aggregation level is 4 when the duration of CORESET 0 is 1 symbol length, and the maximum aggregation level is 8 when the duration of CORESET 0 is 2 symbol length. If the duration of CORESET 0 increases to 4 symbol length, the maximum aggregation level may be 16.

A maximum aggregation level increases from 8 (a duration is 2 symbol length) to 16 when the duration of CORESET 0 is 4 symbol length in a case that the bandwidth of the UE is 24 PRBs.

The UE determines that the duration of CORESET 0 is 8 symbol length based on the bandwidth of the UE being less than 48 PRBs and the number of the receiving antennas of the UE being 1.

In some embodiments, X is set to be 48, and Z is set to be 1, so that the number of PRBs of CORESET 0 may be 24. A maximum aggregation level is 4 when the duration of CORESET 0 is 1 symbol length, and the maximum aggregation level is 8 when the duration of CORESET 0 is 2 symbol length. If the duration of CORESET 0 increases to 8 symbol length, the maximum aggregation level may be 32.

A maximum aggregation level increases from 8 (a duration is 2 symbol length) to 32 when the duration of CORESET 0 is 8 symbol length in a case that the bandwidth of the UE is 24 PRBs.

In some embodiments, the UE may determine the duration of CORESET 0 based on the number of the receiving antennas of the UE. In some embodiments, the UE may determine that the duration of CORESET 0 is M symbol length based on the number of the receiving antennas of the UE being Z.

In some embodiments, Z is set to be 2, so that the number of PRBs of CORESET 0 may be 24. A maximum aggregation level is 4 when the duration of CORESET 0 is 1 symbol length, and the maximum aggregation level is 8 when the duration of CORESET 0 is 2 symbol length. If the duration of CORESET 0 increases to 4 symbol length, the maximum aggregation level may be 16.

In some embodiments, Z is set to be 1, so that the number of PRBs of CORESET 0 may be 24. A maximum aggregation level is 4 when the duration of CORESET 0 is 1 symbol length, and the maximum aggregation level is 8 when the duration of CORESET 0 is 2 symbol length. If the duration of CORESET 0 increases to 8 symbol length, the maximum aggregation level may be 32.

In some embodiments, the UE may determine the duration of the control resource set based on a type of the UE. In some embodiments, the control resource set is CORESET 0, and the UE may determine the duration of CORESET 0 based on the type of the UE.

In some embodiments, the type of the UE may be determined by a preset coverage recovery value. It is determined that the type of the UE is type 3 based on the coverage recovery value being 3 dB, it is determined that the type of the UE is type 6 based on the coverage recovery value being 6 dB, or it is determined that the type of the UE is type 9 based on the coverage recovery value being 9 dB.

In some embodiments, the type of the UE may be determined by at least one of the bandwidths of the UE and the number of the receiving antennas of the UE.

In some embodiments, when the bandwidth of the UE is less than 48 PRBs and the number of the receiving antennas is 2, it may be determined that the type of the UE is type 3. When the bandwidth of the UE is less than 48 PRBs and the number of the receiving antennas is 1, it may be determined that the type of the UE is type 6 or type 9.

Alternatively, when the number of the receiving antennas is 2, it may be determined that the type of the UE is type 3. When the number of the receiving antennas is 1, it may be determined that the type of the UE is type 6 or type 9.

After the type of the UE is determined, the UE may determine the duration of the control resource set based on the type of the UE.

In some embodiments, it is determined that the duration of the control resource set is 4 symbol length based on the type of the UE being type 3, it is determined that the duration of the control resource set is 8 symbol length based on the type of the UE being type 6, or it is determined that the duration of the control resource set is 8 symbol length based on the type of the UE being type 9.

Accordingly, in some embodiments, it is determined that the duration of CORESET 0 is 4 symbol length based on the type of the UE being type 3, it is determined that the duration of CORESET 0 is 8 symbol length based on the type of the UE being type 6, or it is determined that the duration of CORESET 0 is 8 symbol length based on the type of the UE being type 9.

In the embodiments of the present disclosure, with the duration of the control resource set as determined above, the maximum aggregation level may be increased. In existing techniques, when the bandwidth of the UE is 24 PRBs, the maximum aggregation level is 4 or 8 (corresponding to the duration of the control resource set of 1 symbol length or 2 symbol length, respectively). By the embodiments of the present disclosure, the duration of the control resource set determined by the UE is 4 symbol length or 8 symbol length, which is equivalent to increasing the maximum aggregation level to 16 or 32, thereby increasing a coding gain.

In some embodiments, based on the duration of the control resource set being 8 symbol length, a start symbol of a control resource set corresponding to a first synchronization signal block in a time slot is 8, and a start symbol of a control resource set corresponding to a second synchronization signal block in the time slot is 0. With the above configuration, a resource collision between the synchronization signal block and its corresponding control resource set may be effectively avoided.

Accordingly, based on the duration of CORESET 0 being 8 symbol length, a start symbol of CORESET 0 corresponding to a first synchronization signal block in a time slot is 8, and a start symbol of CORESET 0 corresponding to a second synchronization signal block in the time slot is 0.

From above, in the embodiments of the present disclosure, by receiving signaling from a network side, and determining configuration of a control resource set based on the signaling, a low-complexity UE may be able to adaptively determine configuration of the control resource set.

FIG. 2 is a structural diagram of an apparatus 20 for determining configuration of a control resource set according to an embodiment. The apparatus 20 includes a receiving circuitry 201 and a determining circuitry 202.

The receiving circuitry 201 is configured to receive signaling, and the determining circuitry 202 is configured to determine the configuration of the control resource set based on the signaling.

In some embodiments, more details of the receiving circuitry 201 and the determining circuitry 202 may be referred to the above descriptions of S101 and S102 and are not repeated here.

In some embodiments, the apparatus 20 may correspond to a chip (such as a baseband chip) with a data processing function in a UE, or to a chip module containing a chip (such as a baseband chip) with a data processing function in a UE, or to a UE.

In some embodiments, modules/units included in each apparatus and product described in the above embodiments may be software modules/units, hardware modules/units, or a combination of software modules/units and hardware modules/units.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a computer-readable storage medium having computer instructions stored therein is provided, wherein when the computer instructions are executed, any one of the above methods is performed.

In an embodiment of the present disclosure, an apparatus for determining configuration of a control resource set which includes a memory, and a processor is provided, wherein the memory has computer instructions stored therein, and when the processor executes the computer instructions, any one of the above methods is performed.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for determining configuration of a control resource set, comprising:
receiving signaling; and
determining the configuration of the control resource set based on the signaling.

2. The method according to claim 1, wherein the signaling is Master Information Block (MIB) signaling.

3. The method according to claim 1, wherein the control resource set is a control resource set with an identity of 0.

4. The method according to claim 1, wherein said determining the configuration of the control resource set based on the signaling comprises:
determining a duration of the control resource set based on a parameter.

5. The method according to claim 4, wherein said determining a duration of the control resource set based on a parameter comprises:
determining the duration of the control resource set based on a coverage recovery value;
determining the duration of the control resource set based on at least one of bandwidth of a User Equipment (UE) and a number of receiving antennas of the UE; or
determining the duration of the control resource set based on a type of the UE.

6. The method according to claim 5, wherein said determining the duration of the control resource set based on a coverage recovery value comprises at least one of the following:
determining that the duration of the control resource set is 4 symbol length based on the coverage recovery value being 3 dB;
determining that the duration of the control resource set is 8 symbol length based on the coverage recovery value being 6 dB; or
determining that the duration of the control source set is 8 symbol length based on the coverage recovery value being 9 dB.

7. The method according to claim 5, wherein said determining the duration of the control resource set based on at least one of bandwidth of a UE and a number of receiving antennas of the UE comprises:
determining that the duration of the control resource set is M symbol length based on the bandwidth of the UE being less than X physical resource blocks and the number of the receiving antennas of the UE being Z.

8. The method according to claim 7, wherein said determining that the duration of the control resource set is M symbol length comprises at least one of the following:
determining that the duration of the control resource set is 4 symbol length based on the bandwidth of the UE being less than 48 physical resource blocks and the number of the receiving antennas of the UE being 2; or
determining that the duration of the control resource set is 8 symbol length based on the bandwidth of the UE being less than 48 physical resource blocks and the number of the receiving antennas of the UE being 1.

9. The method according to claim 5, wherein said determining the duration of the control resource set based on a type of the UE comprises at least one of the following:
determining that the duration of the control resource set is 4 symbol length based on the type of the UE being type 3;
determining that the duration of the control source set is 8 symbol length based on the type of the UE being type 6; or
determining that the duration of the control source set is 8 symbol length based on the type of the UE being type 9.

10. The method according to claim 9, wherein the type of the UE is determined by at least one of the following:
the coverage recovery value; or
at least one of the bandwidths of the UE and the number of the receiving antennas of the UE.

11. The method according to claim 10, wherein a mapping relation between the type of the UE and the coverage recovery value comprises at least one of the following:
the type of the UE being type 3 based on the coverage recovery value being 3 dB;
the type of the UE being type 6 based on the coverage recovery value being 6 dB; or
the type of the UE being type 9 based on the coverage recovery value being 9 dB.

12. The method according to claim 10, wherein a mapping relation between the type of the UE and the at least one of the bandwidths of the UE and the number of the receiving antennas of the UE comprises:
determining that the type of the UE is N based on the bandwidth of the UE being less than X physical resource blocks and the number of the receiving antennas of the UE being Z.

13. The method according to claim 12, wherein the mapping relation between the type of the UE and the at least one of the bandwidths of the UE and the number of the receiving antennas of the UE comprises at least one of the following:
determining that the type of the UE is 3 based on the bandwidth of the UE being less than 48 physical resource blocks and the number of the receiving antennas of the UE being 2; or
determining that the type of the UE is 6 or 9 based on the bandwidth of the UE being less than 48 physical resource blocks and the number of the receiving antennas of the UE being 1.

14. The method according to claim 6, wherein based on the duration of the control resource set being 8 symbol length, a start symbol of a control resource set corresponding to a first synchronization signal block in a time slot is 8, and a start symbol of a control resource set corresponding to a second synchronization signal block in the time slot is 0.

15. (canceled)

16. A non-transitory computer readable storage medium storing one or more programs, the one or more programs comprising computer instructions, which, when executed by a processor, cause the processor to:
receive signaling; and
determine configuration of a control resource set based on the signaling.

17. An apparatus for determining configuration of a control resource set, comprising a memory and a processor, wherein the memory stores one or more programs, the one or more programs comprising computer instructions, which, when executed by the processor, cause the processor to:
receive signaling; and
determine configuration of a control resource set based on the signaling.

18. The method according to claim 7, wherein based on the duration of the control resource set being 8 symbol length, a start symbol of a control resource set corresponding to a first synchronization signal block in a time slot is 8, and a start symbol of a control resource set corresponding to a second synchronization signal block in the time slot is 0.

19. The method according to claim 8, wherein based on the duration of the control resource set being 8 symbol length, a start symbol of a control resource set corresponding to a first synchronization signal block in a time slot is 8, and a start symbol of a control resource set corresponding to a second synchronization signal block in the time slot is 0.

20. The method according to claim 9, wherein based on the duration of the control resource set being 8 symbol length, a start symbol of a control resource set corresponding to a first synchronization signal block in a time slot is 8, and a start symbol of a control resource set corresponding to a second synchronization signal block in the time slot is 0.

21. The apparatus according to claim 17, wherein the processor is further caused to:
determine a duration of the control resource set based on a parameter.
